(19) United States
(12) Patent Application Publication
(10) Pub. No.: US 2011/0261097 A1
(43) Pub. Date: Oct. 27, 2011

(54) DRIVER CIRCUIT FOR DRIVING A PRINT HEAD OF AN INKJET PRINTER

(75) Inventors: Johannes M.M. SIMONS, Venlo (NL); Erwin SCHRIJVER, Beuningen (NL)

(73) Assignee: OCE TECHNOLOGIES B.V., Venlo (NL)

(21) Appl. No.: 13/099,520

(22) Filed: May 3, 2011

Related U.S. Application Data
(63) Continuation of application No. PCT/EP2009/063894, filed on Oct. 22, 2009.

(30) Foreign Application Priority Data
Nov. 5, 2008 (EP) 08168333.6

(51) Int. Cl. B41J 29/38

(52) U.S. Cl. 347/10

(57) ABSTRACT

An inkjet printing apparatus includes a print head having an ink duct, a piezoelectric element operatively coupled to the ink duct, and a control device for controlling an ink drop ejection from the ink duct by actuation of the piezoelectric element. The control device includes a current source, a number of power supplies, and a switch, connected between the current source and the number of power supplies. The current source is configured to generate a current for actuating the piezoelectric element by charging and discharging. The switch is configured to connect the current source and one of the number of power supplies. The one of the number of power supplies is selected such that a lowest voltage difference over the current source exists.

### CROSS-REFERENCE TO RELATED APPLICATIONS

This application is a Continuation of copending PCT International Application No. PCT/EP2009/063894 filed on Oct. 22, 2009, which designated the United States, and on which priority is claimed under 35 U.S.C. §120. This application also claims priority under 35 U.S.C. §119(a) on Patent Application No. 08168333.6, filed in Europe on Nov. 5, 2008. The entire contents of each of the above documents is hereby incorporated by reference into the present application.

### BACKGROUND OF THE INVENTION

1. Field of the Invention

The present invention relates to an inkjet printing apparatus, comprising a print head, the print head comprising an ink duct, a piezoelectric element operatively coupled to the ink duct, and a control device configured to control ink drop ejection from the ink duct by actuation of the piezoelectric element.

2. Description of Background Art

Inkjet printers comprising piezoelectric elements are well known in the background art. In such printers, each ink duct is operatively connected to a piezoelectric element. A control device controls actuation of a piezoelectric element, so that it deforms and a volume change is achieved in the ink duct associated with the piezoelectric element. A resulting pressure wave that is thereby generated in the ink duct, leads to a drop of ink being ejected from a nozzle of the duct. Each point of time that the piezoelectric element, having properties comparable with a capacitor with capacitance C, is actuated by charging and discharging by a current source, an amount of power equal to ½ CV² is dissipated in the driver circuit for each charging of the piezoelectric element and an amount of power equal to ½ CV² is dissipated for each discharging of the piezoelectric element, wherein V represents a voltage present over the current source.

In an inkjet printer with, for example, 128 nozzles per print head such power dissipation results in a substantial loss of energy. When using a higher jet frequency or a larger number of nozzles per print head the energy loss becomes even larger.

From U.S. Pat. No. 7,049,756, a capacitive load driving circuit is known for charging and discharging a capacitive load. The capacitive load driving circuit is provided with a voltage divider for dividing a power supply voltage V_{A} into a plurality of different voltages and a plurality of capacitors with capacitance C_{A}. With this circuit, it is possible to collect and reuse energy accumulated in a capacitive load. However, the dissipated power is still large since the power supply voltage is constantly present over the plurality of capacitors causing power dissipation during charging and discharging of the piezoelectric element of each equal to the amount of ½ C_{A}V_{A}².

### SUMMARY OF THE INVENTION

An object of the present invention is to reduce the power dissipation during charging and discharging of a piezoelectric element in the print head. According to the present invention, this object is achieved by an inkjet printing apparatus, comprising a print head, the print head comprising an ink duct, a piezoelectric element operatively coupled to the ink duct, and a control device configured to control an ink drop ejection from the ink duct by actuation of the piezoelectric element. The control device comprises a current source, a number of power supplies, and a switch, connected between the current source and the number of power supplies, wherein the current source is configured to generate a current for actuating the piezoelectric element by charging and discharging, and the switch is configured to connect the current source and one of the number of power supplies, the one of the number of power supplies being selected such that a lowest voltage difference over the current source exists.

The applicant has recognized that power dissipation released by the current source may be reduced by reducing the voltage difference over the current source. Therefore a low voltage difference is created over the current source. The current source is provided to generate a current for actuating the piezoelectric element by charging and discharging. A load voltage over the piezoelectric element is thereby generated. A switch and a number of power supplies are provided, the current source being connected between the piezoelectric element and the switch. A voltage difference over the current source is equal to a voltage difference between the load voltage and a voltage of one of the power supplies, the one power supply being connected through the switch. A low voltage difference over the current source is established by switching the switch in such a position that the lowest available supply voltage above the load voltage over the piezoelectric element is selected.

The term “switch” has spread to a variety of digital active devices such as transistors and logic gates whose function is to change their output state between two logic levels or connect different signal lines. Each kind of transistor may be used as a switch. Examples of transistors often used as a switch are a Bipolar Junction Transistor (BJT) or Field Effect Transistors (MOSFET or JFET). For reasons of convenience, the switch as meant in the present invention is represented in the figures belonging to the present application as an electromechanical device with one or more sets of electrical contacts. Each set of contacts can be in one of two states: either ‘closed’ meaning the contacts are touching and electricity can flow between them, or ‘open’, meaning the contacts are separated and non-conducting.

The figures do not indicate that the switch as meant in the embodiments of the present invention is implemented as such an electromechanical device. Moreover, in the embodiments in the present invention, electronic switches are preferred.

The switch comprises a number of input terminals and at least one output terminal. The number of input terminals are connected to the number of power supplies. The at least one output terminal is connected to the current source.

Each position of the switch corresponds to an input terminal of the switch and supplies a different voltage level. Such a voltage level may depend on the configuration of the number of power supplies which are corresponding to the engaged input terminal. Dependent on to which one of the number of input terminals the switch is switched, a predetermined supply voltage level is supplied at the output terminal of the switch that is connected to the current source.

Dependent on the number of input terminals, in case switching positions, of the switch, the level of the supply voltage may be selected out of a number of discrete levels of supply voltage between 0 V and a predetermined maximum supply voltage. When no power supply is switched into the circuit, the supply voltage will be 0 V and if a number of power supplies are switched into the circuit, the supply voltage may be higher than 0 V up to the predetermined maximum supply voltage. The supply voltage may be high enough to establish an actuation of the piezoelectric element resulting in an ink drop ejection.

By switching the power supplies into the circuit as described above, power dissipation released by the current source during the charging and discharging of the piezoelectric element may be significantly reduced. It is noted that a reduction of power dissipation of the current source may depend on the number of input terminals. In general, the reduction is larger in case that the number of input terminals is larger.

In the case of equidistant voltage levels at the input terminals of the switch, a significant reduction may be achieved corresponding to the number of input terminals.

In an embodiment of the present invention, the charging and discharging of the piezoelectric element is done by a current source, for example a linear current source. The current from the linear current source is controlled. The current source is switched at the output terminal of a switch, which has the lowest available voltage difference with the load voltage of the piezoelectric element. This may be done by a known control device, e.g. based on a voltage drop across the current source as switching criterion. If the voltage drop gets below a certain minimum (e.g. about zero), the switch may be put one switch position higher to the next input terminal, which supplies a higher voltage.

During the charging phase, the switch may start at an input terminal supplying a predetermined voltage level, stepping from one switch position to another switch position to at last an input terminal supplying the highest available voltage during the last part of the charging.

Discharging may be controlled in an opposite way. A first terminal to discharge to, may be an input terminal supplying a second highest voltage, a last input terminal may supply a voltage level of 0 V.

Each piezoelectric element may have its own control device and may operate independently of other control devices, giving this approach a large flexibility. Deviations and ripple at the voltage input terminals do not disturb the functioning, because the control device uses the voltage drop across the current source as switching criterion. A voltage ladder may be constructed by selecting a plurality of adequate voltage levels. The voltage ladder may be constructed only once per piezoelectric element.

In an embodiment, the current source may be a controlled current source, such as a voltage controlled current source or a current controlled current source. This may be advantageous since the current produced by the controlled current source may determine the waveform of the output voltage. In the case that the current is held constant during charging of the piezoelectric element, a linear growth of the voltage level at the piezoelectric element will be achieved. However, for arbitrary waveforms the current may be controlled such that a desired waveform is established over the piezoelectric element.

In an embodiment, the number of power supplies may be a number of direct voltage sources (DC). By applying a direct voltage source (DC) like a switched-mode power supply (SMPS), the dissipation power loss and heat in the direct voltage source is minimized as well as the power dissipation produced by the current source. A good design may have an efficiency of up to 95%.

In an embodiment, the number of power supplies is connected in series. The number of serialized power supplies may generate a voltage difference level up to the sum of the voltages of the number of power supplies. Power dissipated by the current source may be reduced during the charging and discharging of the piezoelectric element. In case that each power supply is able to generate a same voltage, a power dissipation reduction may be achieved with a factor approximately equal to the number of power supplies. If, for instance four power supplies, being connected in series, with the same voltage level are used, during charging of the piezoelectric element a power dissipation of for instance 400 W may reduce to 100 W. In general, the reduction is larger in case that the number of power supplies is larger.

In an embodiment, an inkjet printing apparatus may comprise a number of piezoelectric elements and a number of current sources. The number of power supplies and the number of current sources may be operatively connected by means of a multiplexer. The multiplexer may comprise a number of input terminals and a number of output terminals. Each power supply may be connected to a respective input terminal and each current source may be connected between a respective output terminal and a respective one of the number of piezoelectric elements. In this manner, only one switching device, the multiplexer, is embodied and this may be advantageous in the case that each piezoelectric element needs to be charged according to an approximately same voltage ladder by switching for each step on the voltage ladder to a next higher voltage level by connecting to a corresponding input terminal of the multiplexer. For discharging the same advantage may be achieved.

In an embodiment, the inkjet printing apparatus may comprise a number of piezoelectric elements, wherein each piezoelectric element has a respective switch. In opposition to the previous embodiment, this embodiment may be advantageous in the case that for each piezoelectric element a different type of charging is required. This may for example depend on the arrangement of the piezoelectric elements on the print head.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will now be explained further with reference to the accompanying drawings, wherein:

FIG. 1 is a schematic representation showing an inkjet printing apparatus;

FIG. 2 is a schematic representation showing an ink duct assembly of an inkjet printing apparatus and its associated piezoelectric element;

FIG. 3 is a schematic illustration showing a control device according to an embodiment of the invention for charging and discharging a piezoelectric element;

FIGS. 4a-4c is a diagrams showing voltages on a piezoelectric element in a process of charging and discharging of the piezoelectric element;

FIG. 5a is a schematic illustration showing a control device according to an embodiment of the present invention, in which embodiment more than one piezoelectric element has been arranged;

FIG. 5b is a schematic illustration showing a control device according to an embodiment of the present invention, the control device comprising a switch for each piezoelectric element;

FIG. 6 is a schematic illustration showing a control circuit according to an embodiment of the present invention, the control circuit comprising power supplies which have been arranged in a parallel manner;

FIG. 7 is a diagram showing voltages on a piezoelectric element in a process of charging and discharging of the piezoelectric element;

FIG. 8a is a schematic illustration showing an embodiment of the present invention in which a switch terminal and power supply is connected to a first terminal of the piezoelectric element and a second terminal of the piezoelectric element to a control circuit; and

FIG. 8b is a diagram showing voltages on a piezoelectric element in a process of charging and discharging of the piezoelectric element according to the illustration of FIG. 8a.

### DETAILED DESCRIPTION OF THE INVENTION

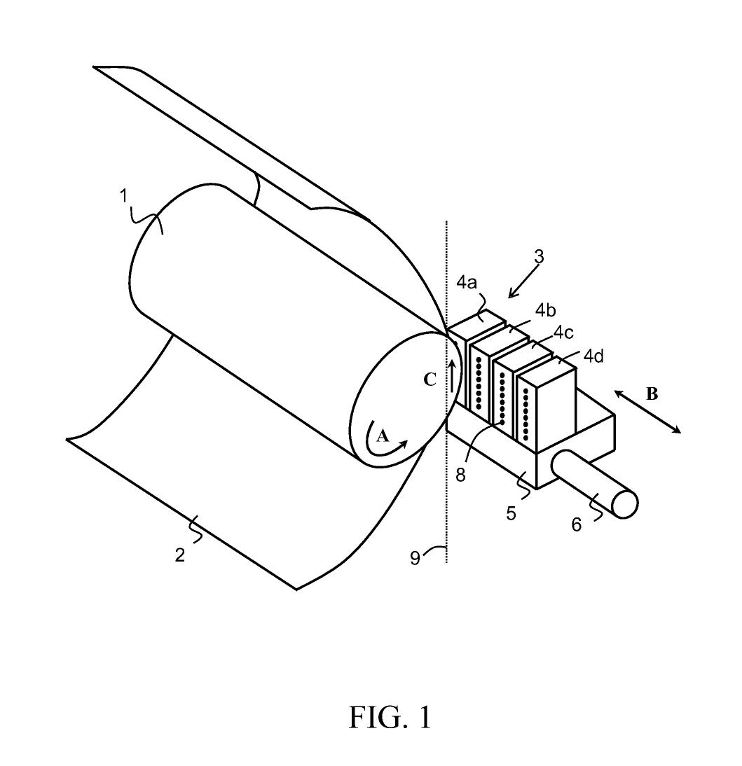

An inkjet printing apparatus is shown in FIG. 1. According to this embodiment, the inkjet printing apparatus comprises a roller 1 used to support a receiving medium 2, such as a sheet of paper or a transparency, and to move it along a carriage 3 in direction A. The carriage 3 comprises a carrier 5 on which four print heads 4a, 4b, 4c and 4d have been mounted. Each print head may contain its own color, in this case cyan (C), magenta (M), yellow (Y) and black (K), respectively, but in an embodiment each print head may comprise a same substance to be applied onto the medium 2, for example.

The roller 1 may rotate around its own axis as indicated by arrow A. In this manner, the receiving medium may be moved in a sub-scanning direction C relative to the carrier 5 parallel to an axis 9, and therefore also relative to the print heads 4a-4d. The carriage 3 may be moved in reciprocation using suitable drive mechanisms (not shown) in a direction indicated by double arrow B, substantially parallel to roller 1. To this end, the carrier 5 is moved across a guide rod 6. This direction is generally referred to as the main scanning direction. In this manner, the receiving medium may be fully scanned by the print heads 4a-4d.

According to the embodiment as shown in this figure, each print head 4a-4d may comprise a number of internal ink ducts (not shown), each with its own exit opening (nozzle) 8. The nozzles in this embodiment form one row per print head perpendicular to the axis of roller 1 (i.e. the row extends in the sub-scanning direction C). According to a practical embodiment of an inkjet printer, the number of ink ducts per print head is greater and the nozzles are arranged over two or more rows. Each ink duct comprises a piezoelectric element (not shown) that may generate a pressure wave in the ink duct so that an ink drop is ejected from the nozzle of the associated duct in the direction of the receiving medium. The piezoelectric elements may be actuated image-wise via an associated control circuit (not shown). In this manner, an image built up of ink drops may be formed on receiving medium 2.

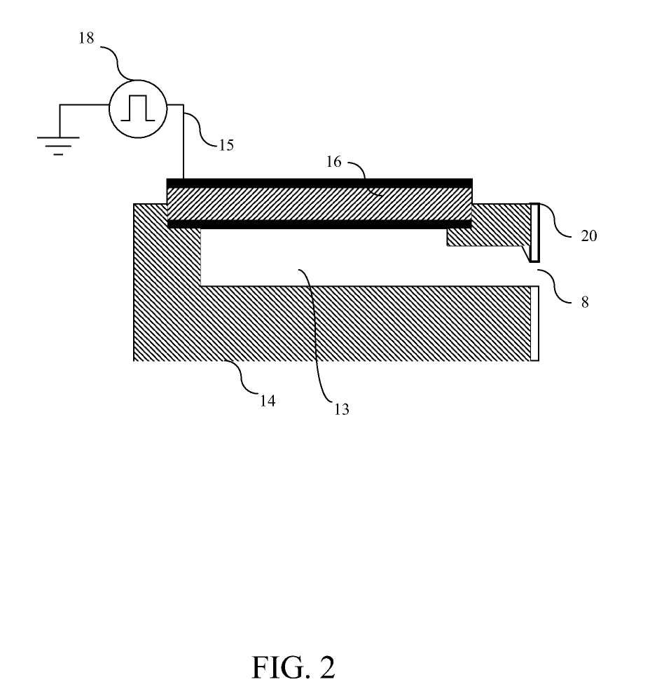

An ink duct 13 is shown in FIG. 2 comprising a piezoelectric element 16. In the illustrated embodiment, the ink duct 13 is formed by a groove in base plate 14 and is limited at the top mainly by the piezoelectric element 16. The ink duct 13 changes into an exit opening 8 at the end, this opening being partly formed by a nozzle plate 20 in which a recess has been made at the position of the ink duct 13. When a signal generator 18 applies a signal on the piezoelectric element 16 via actuation circuit 15, the piezoelectric element 16 deforms in the direction of the ink duct 13. This produces a sudden pressure rise in the ink duct 13, which in turn generates a pressure wave in the ink duct 13. If the pressure wave is strong enough, an ink drop is ejected from exit opening 8.

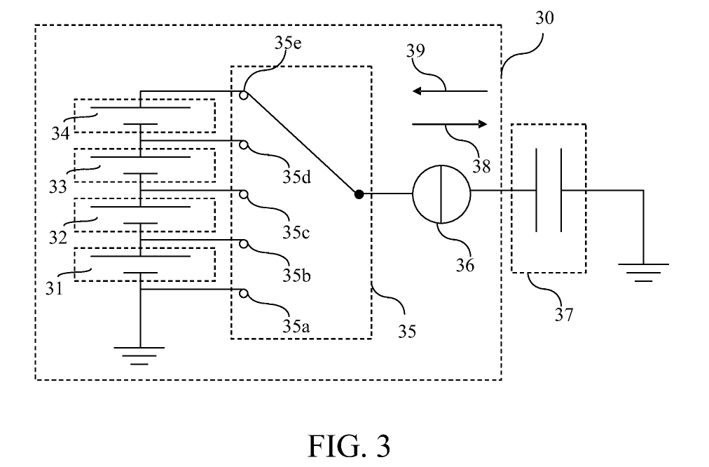

FIG. 3 shows a schematic illustration of a control circuit 30 and a piezoelectric element 37 which is connected between ground and a first terminal of a current source 36. The piezoelectric element 37 may be charged by means of the current source 36.

A second terminal of the current source 36 is connected to an output terminal of a switch 35. The switch 35 is connected to a number of power supplies 31, 32, 33, 34, each delivering a voltage of x V. The power supplies 31, 32, 33, 34 are connected in series. The switch 35 has five input terminals 35a, 35b, 35c, 35d, 35e. A first input terminal 35a is connected to ground, supplying a voltage level of 0 V. A second input terminal 35b is connected to a terminal of the first power supply 31, supplying a voltage level of x V. A third input terminal 35c is connected to a terminal of the second power supply 32, supplying a voltage level of 2x V. A fourth input terminal 35d is connected to a terminal of the third power supply 33, supplying a voltage level of 3x V. A fifth input terminal 35e is connected to a terminal of the fourth power supply 34, supplying a voltage level of 4x V.

To establish ink drop ejection from the ink duct the piezoelectric element 37 needs to be actuated. Actuation is established by charging the piezoelectric element 37 via the current source 36. A pressure wave due to the actuation is strong enough to eject an ink drop from the nozzle of the ink duct as described herein-above with reference to FIG. 2. The charging of the piezoelectric element 37 is managed by the control circuit 30. The control circuit 30 comprises the current source 36, which generates a current towards the piezoelectric element 37 according to a first directed arrow 38. When the voltage difference over the piezoelectric element is increased to a predetermined maximum level, e.g. 4x V, the actuation occurs resulting in a pressure wave in the ink duct, which leads to a drop of ink being ejected from the nozzle of the ink duct.

At the start of the actuation, the piezoelectric element 37 may not be charged and the switch 35 may be switched towards the first input terminal 35a. Then the current source 36 is starting to charge the piezoelectric element 37 and at the same time the switch 35 is switched towards the second input terminal 35b such that a voltage difference over the current source 36 of x V is established. A voltage difference over the piezoelectric element 37 increases. The voltage difference over the current source 36 results in power dissipation. The voltage difference over the current source 36 decreases to a level of 0 V due to the voltage difference over the piezoelectric element 37 reaching x V. As soon as the voltage difference over the current source 36 reaches a level of 0 V, the switch 35 alters the switch position from the second input terminal 35b towards the third input terminal 35c. The third input terminal 35c is supplying a voltage of 2x V By doing so, the voltage difference over the current source 36 is increased towards approximately x V and power is dissipated over the current source 36 directly after the moment of altering the switch position. The power dissipation may start to decrease again, if the voltage difference over the piezoelectric element increases further.

The current from the current source 36 is still charging the piezoelectric element 37 towards a higher voltage difference over the piezoelectric element. Power is starting again to be dissipated by the current source 36, since a voltage difference over the current source 36 is established. When the voltage difference over the piezoelectric element 37 has increased to a level of 2x V and the voltage difference over the current source 36 has thereby decreased to a level of 0 V, the switch 35 alters the switch position from the third input terminal 35c towards to fourth input terminal 35d. The fourth input terminal 35d is supplying a voltage of 3x V. By doing so, the voltage difference over the current source 36 is increased towards approximately x V, thereby dissipating power over the current source 36. Analogue to the above description, the switch 35 may be switched towards the fifth input terminal 35e supplying a voltage of 4x V. By switching towards the fifth input terminal 35e, the voltage difference over the current source will be approximately x V and the voltage difference over the piezoelectric element 37 increases to a level of 4x V. At a voltage difference of 4x V over the piezoelectric element 37, the ejection of the ink drop takes place. During a short time period the voltage difference will stay at this maximum voltage difference of 4x V.

Before a next actuation of the piezoelectric element 37, the piezoelectric element 37 needs to be discharged. To establish discharging of the piezoelectric element 37, the current from the current source 36 is altered into an opposite direction indicated by a second arrow 39 towards the switch 35. The process of discharging the piezoelectric element 37 is reversible with respect to the process of charging the piezoelectric element 37. After discharging is started, the voltage difference over the piezoelectric element 37 decreases. The voltage difference over the current source 36 is increasing and power is dissipated again. As soon as the voltage difference over the piezoelectric element 37 has decreased to a level of 3x V, the switch 35 is switched towards the fourth input terminal 35d. Since the fourth input terminal supplies a voltage of 3x V, the voltage difference over the current source 36 becomes approximately 0 V.

The switch 35 is further switched towards the third input terminal 35c, when the voltage difference over the piezoelectric element 37 has decreased to 2x V, towards the second input terminal 35b, when the voltage difference over the piezoelectric element 37 has decreased to x V, and finally towards the first input terminal 35a, when the voltage difference over the piezoelectric element 37 has decreased to 0 V.

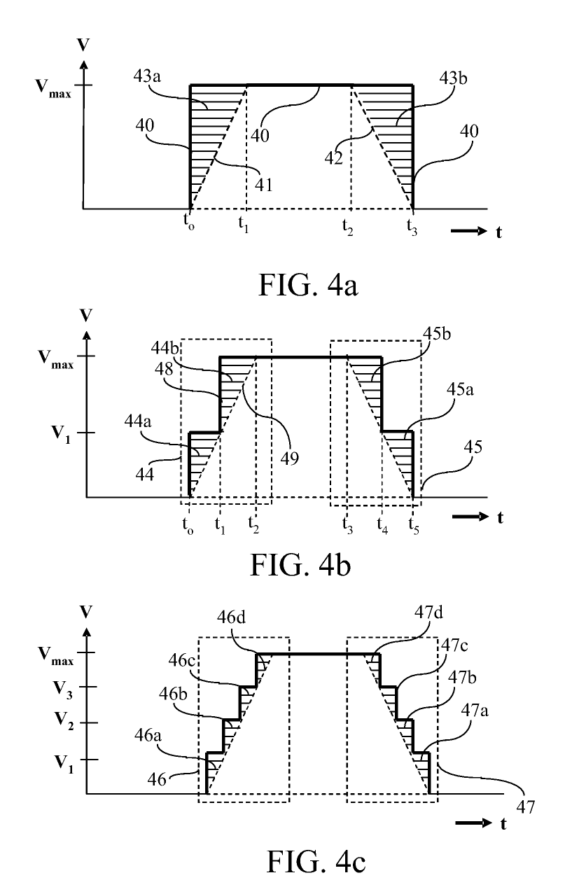

By switching to an input terminal 35a, 35b, 35c, 35d, 35e which supplies a voltage which has a low voltage difference with the voltage present over the piezoelectric element 37, the voltage difference over the current source 36 remains below a level of the x V during charging and discharging. Thus the voltage difference over the current source 36 is limited such that the power dissipation during charging and discharging of the piezoelectric element 37 is significantly reduced. The calculation of the amount of power dissipation reduction during charging and discharging as described above is explained on the basis of FIGS. 4a-4c.

The current source 36 is connected between the switch and the piezoelectric element. In a known circuit, a voltage difference over a piezoelectric element at actuation time is applied at once onto a current source. This is illustrated in FIG. 4a. In FIG. 4a a graph is shown with a voltage level represented on a vertical axis, whilst time is represented on a horizontal axis. Bold line 40 shows the voltage at an output terminal of the switch 35 (see FIG. 3) during an actuation cycle in the case of one voltage step. A dashed line 41 shows the voltage difference in time over the piezoelectric element 37 (see FIG. 3) during charging, a second dashed line 42 shows the voltage difference during discharging of the piezoelectric element. At a first point of time t₀ the switch of the switch 35 is switched from ground 35a to the fifth input terminal 35e, delivering at once a maximum voltage Vₘₐₓ to the output terminal of the switch 35. From the first point of time t₀ until a second point of time t₁ the current source 36 is charging the piezoelectric element 37 and the voltage over the piezoelectric element increases from 0 V towards the maximum voltage Vₘₐₓ. From the second point of time t₁ to a third point of time t₂ the voltage over the piezoelectric element remains approximately constant at a maximum level Vₘₐₓ in order to establish an actuation of the piezoelectric element 37. After actuation, at the third point of time t₂ the current source 36 is starting to discharge the piezoelectric element 37 such that the voltage difference over the piezoelectric element 37 decreases from Vₘₐₓ towards 0 V at a fourth point of time t₃. The surface of the hatched area 43a is a measure for power dissipation in the current source 36 during charging of the piezoelectric element 37 and the surface of the hatched area 43b is a measure for power dissipation in the current source 36 during discharging of the piezoelectric element 37.

FIGS. 4b-4c show diagrams according to embodiments of the present invention, each diagram comprising a graph of the voltage level on a vertical axis against time on a horizontal axis, output through an output terminal of the switch 35 (see FIG. 3) between the start time of charging the piezoelectric element 37 (see FIG. 3) and the end time of discharging the piezoelectric element 37. The graph is forming two so-called voltage ladders. A voltage ladder may comprise voltage level steps to be applied through the switch 35 to the current source 36 (see FIG. 3) either in a process of charging the piezoelectric element 37 or either in a process of discharging the piezoelectric element 37.

FIG. 4b shows, according to an embodiment of the present invention, a graph of two voltage ladders 44, 45, each voltage ladder comprising two voltage level steps. The voltage at an output terminal of the switch 35 is represented by bold line 48 which follow in discrete steps a dashed trapezoidal curve 49. At the beginning of a first step, at a first point of time t₀, a first voltage V₁ is set, for example by switching the switching device to the third output terminal 35c. During the time period between the first point of time t₀ and a second point of time t₁ the piezoelectric element 37 is charged and the voltage difference over the piezoelectric element 37 increases from 0 V towards V₁ V. At the beginning of a second step, at the second point of time t₁ a second voltage Vₘₐₓ is set, for example by switching the switching device to the fifth output terminal 35e. The first and second voltage are selected such that V₁=½ Vₘₐₓ. During the time period between the second point of time t₁ and a third point of time t₂ the piezoelectric element 37 is charged and the voltage difference over the piezoelectric element 37 increases from V₁ V towards Vₘₐₓ V. The dashed trapezoidal curve 49 represents the voltage over the piezoelectric element 37 during the actuation cycle. Since the total surface of the hatched areas 44a, 44b, 45a, 45b is a measure for power dissipation in the current source 36 during the actuation cycle, the power dissipation in the current source 36 is approximately halved in the case of two voltage level steps as may be calculated when comparing the total surface of the hatched areas 43a, 43b in FIG. 4a with the total surface of the hatched areas 44a, 44b, 45a, 45b in FIG. 4b.

FIG. 4 c illustrates an embodiment comparable to the embodiment illustrated in FIG. 4b. FIG. 4c shows two voltage ladders 46, 47, each voltage ladder comprising four voltage level steps according to the configuration shown in FIG. 3 whereas the embodiment of FIG. 4b comprises two voltage level steps. The operation of the embodiment of FIG. 4c is however essentially similar to the operation of the embodiment of FIG. 4b. In the case of four voltage level steps each input terminal 35a-35e of the switch 35 is used during charging of the piezoelectric element 37. At the beginning of a first step, a first voltage V₁ is set. At the beginning of a second step, a second voltage V₂ is set. At the beginning of a third step, a third voltage V₃ is set. At the beginning of a fourth step, a fourth voltage Vₘₐₓ is set. The first voltage V₁, the second voltage V₂, the third voltage V₃ and the fourth voltage Vₘₐₓ are selected such that V₁=½ V₂=⅓ V₃=¼ Vₘₐₓ. Since the surface of hatched areas 46a, 46b, 46c, 46d, 47a, 47b, 47c, 47d is a measure for power dissipation in the current source 36 during the actuation cycle, the power dissipation in the current source 36 is approximately quartered in the case of four voltage level steps per voltage ladder as may be calculated when comparing the total surface of the hatched areas 43a, 43b in FIG. 4a with the total surface of the hatched areas 46a, 46b, 46c, 46d, 47a, 47b, 47c, 47d in FIG. 4c.

In general, it may be easily calculated that the original amount of power dissipation as shown in FIG. 4a in the current source 36 is divided by approximately n, where n represents the number of voltage level steps per voltage ladder. One may conclude that a minimum of no power dissipation takes place in the ideal situation of an infinite number of voltage level steps. In that case an adjustable power supply may be used. However in practice, a disadvantage of an adjustable power supply may be that the internal power dissipation is relatively large, such that power dissipation is moved from the current source towards the adjustable power supply. In accordance with the present invention, a number of voltage level steps may be calculated to optimize the amount of power dissipation reduction on the basis of a power dissipation in the current source and a power dissipation in the power supplies used in the driver circuit.

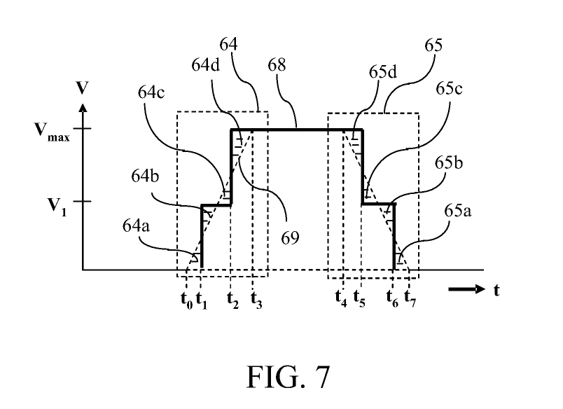

Another embodiment may be contemplated, which may be preferred over the embodiments as shown in FIG. 4b-4c. Such an embodiment is shown in FIG. 7. A graph of two voltage ladders 64, 65 is shown in FIG. 7, each voltage ladder comprising two voltage level steps. A voltage at an output terminal of the switch 35 is represented by bold line 68, which follows in discrete steps a dashed trapezoidal curve 69. A difference with the two voltage ladders 44, 45, shown in FIG. 4b, is the moments in point of time that the switch position is altered. The switch position is not altered when the voltage over the piezoelectric element 37 starts to increase at a first point of time t₀. The switch position is altered a moment further in point of time than the start of the increase of the voltage over the piezoelectric element 37, at a second point of time t₁, but before the voltage over the piezoelectric element 37 reaches the voltage level V₁ which is equal to the voltage present at the next switch position of switch 35. FIG. 7 shows a preferred moment in point of time t₁, namely when the voltage over the piezoelectric element 37 reaches the level of ½ V₁. Next moments in time of altering the switch position may be selected analogously. Since the total surface of the hatched areas 64a, 64b, 64c, 64d, 65a, 65b, 65c, 65d is a measure for power dissipation in the current source 36 during the actuation cycle, the power dissipation in the current source 36 is approximately halved in the case of two voltage level steps as may be calculated when comparing the total surface of the hatched areas 44a, 44b, 45a, 45b in FIG. 4b with the total surface of the hatched areas 64a, 64b, 64c, 64d, 65a, 65b, 65c, 65d in FIG. 7. From FIG. 7 may be concluded that the voltage over the current source 36 is of a level approximately between −½ V₁ and +½ V₁, such that the voltage sign may be negative and even alternating. Because of the fact that a negative voltage may be present over the current source 36 during a substantial amount of time during charging and discharging, the current source 36 may be laid up special requirements in order to function at a negative voltage over the current source 36 or at voltage sign alternation over the current source 36.

In general, it may be easily calculated that the original amount of power dissipation as shown in FIG. 7 in the current source 36 is divided by approximately 2n, where n represents the number of voltage level steps per voltage ladder. This is more advantageous concerning the amount of power dissipation than the division by approximately n in the embodiment according to FIG. 4b-4c.

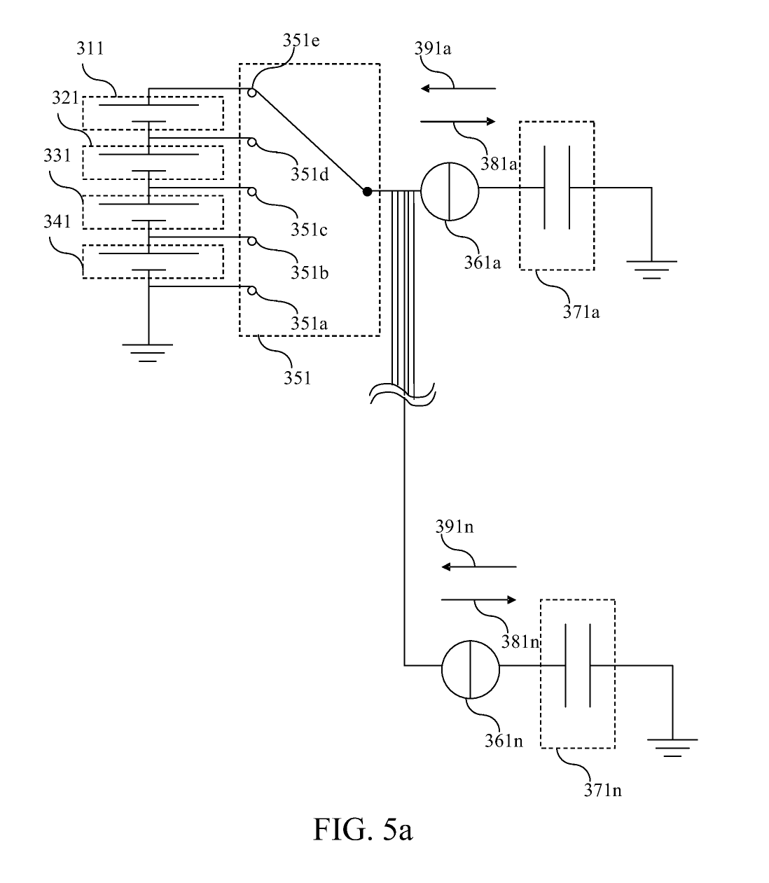

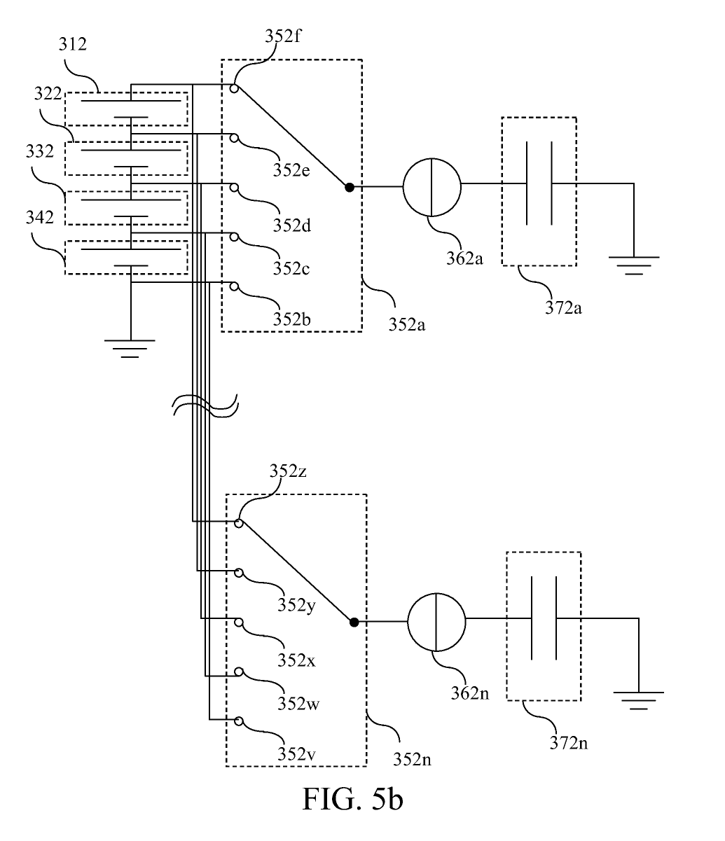

In FIG. 3, only one piezoelectric element 37 is shown. In practice, an inkjet printing apparatus may comprise a plurality of piezoelectric elements and a plurality of current sources for driving a plurality of nozzles independently. A first embodiment is shown in FIG. 5a. A number of power supplies 311, 321, 331, 341, each delivering a voltage of x V, may be connected in series to switch 351 having five input terminals 351a, 351b, 351c, 351d, 351e, outputting voltage levels 0 V, x V, 2x V, 3x V and 4x V, respectively. An output terminal of the switch 351 may be connected to a number of current sources 361a, 361n, of which a first current source 361a and a second current source 361n are shown in FIG. 5a. The current sources 361a, 361n may charge and discharge piezoelectric elements 371a, 371n, respectively, such as described above with respect to FIG. 3. A first piezoelectric element 371a and a second piezoelectric element 371n are shown in FIG. 5a. The charging of the piezoelectric element 371a, 371n is indicated by a first directed arrow 381a, 381n and the discharging of the piezoelectric element 371a, 371n is indicated by a second directed arrow 391a, 391n. According to this embodiment, the actuation of a piezoelectric element may depend on the time needed to charge the piezoelectric element. In case of identical current sources, the actuation of each piezoelectric element may be approximately at the same moment in time. Also, because of the presence of one switch 351, the power dissipation of each current source 361a, 361n may be approximately the same. Nozzles are driven independently by selectively controlling the respective current sources 361a, 361n.

In FIG. 5a, one switch 351 is shown. A second embodiment of a control circuit for use with a plurality of piezoelectric elements is shown in FIG. 5b in which at least two switch 352a, 352n are arranged in the control circuit. A number of power supplies 312, 322, 332, 342, each delivering a voltage of x V, may be connected in series to the at least two switches 352a, 352n. A first switch 352a and a second switch 352n are shown in FIG. 5b. The first switch 352a is configured with five input terminals 352b, 352c, 352d, 352e, 352f, outputting voltage levels 0 V, x V, 2x V, 3x V and 4x V, respectively. The second switch 352n is configured with five input terminals 352v, 352w, 352x, 352y, 352z, outputting voltage levels 0 V, x V, 2x V, 3x V and 4x V, respectively. The first switch 352a is connected to a first current source 362a. The second switch 352n is connected to a second current source 362n. The first current source 362a may charge and discharge a first piezoelectric element 372a. The second current source 362n may charge and discharge a second piezoelectric element 372n. Charging and discharging may be controlled in accordance with the embodiment as described above with respect to FIG. 3. This embodiment has an advantage that the resulting pressure wave being generated in a duct may be different for each corresponding piezoelectric element and therefore making it possible to tune the pressure wave for each piezoelectric element and corresponding duct in order to get an optimal ejection of an ink drop.

In another embodiment, a control circuit comprising a plurality of switches, as shown in FIG. 5b, may be embodied by a control circuit comprising one or more multiplexers with more than one input terminal and more than one output terminal Particularly, one multiplexer may be used with a number of output terminals equal to the number of current sources and a number of input terminals, of which each input terminal supplies a different voltage. Each output terminal may be provided with one of the voltages provided at the number of input terminals, independently.

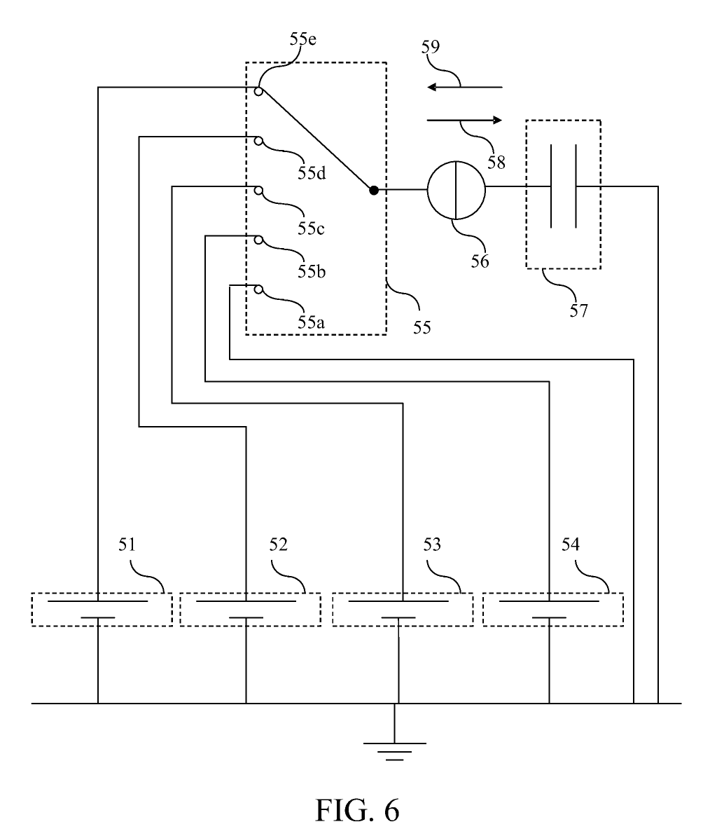

Although the power supplies are connected in series according to FIGS. 3 and 5a-5b, this is no limitation to the present invention. An embodiment with power supplies connected in parallel is shown in FIG. 6. A number of power supplies 51, 52, 53, 54 are connected in parallel and connected to a switch 55 having a number of input terminals 55a, 55b, 55c, 55d, 55e. The switch 55 is also connected to a current source 56 which is connected to a piezoelectric element 57 and therefore able to charge and discharge the piezoelectric element 57. The charging of the piezoelectric element 57 is indicated by a first directed arrow 58 respectively, and the discharging of the piezoelectric element 57 is indicated by a second directed arrow 59. A difference with the embodiments shown in FIGS. 3 and 5a-5b is that the power supplies may deliver different voltages. A first power supply 51 may deliver a voltage of 4x V, a second power supply 52 may deliver a voltage of 3x V, a third power supply 53 may deliver a voltage of 2x V and a fourth power supply 54 may deliver a voltage of x V. In this manner, the switch 55 may be configured such that the five input terminals 55a, 55b, 55c, 55d, 55e output the voltage levels 0 V, x V, 2x V, 3x V and 4x V, respectively. It may be clear to one having ordinary skill in the art that the embodiment shown in FIG. 5 may be varied for example analogously to the variations to the embodiment, which is shown in FIG. 3, being the variations being shown in FIG. 5a-5b.

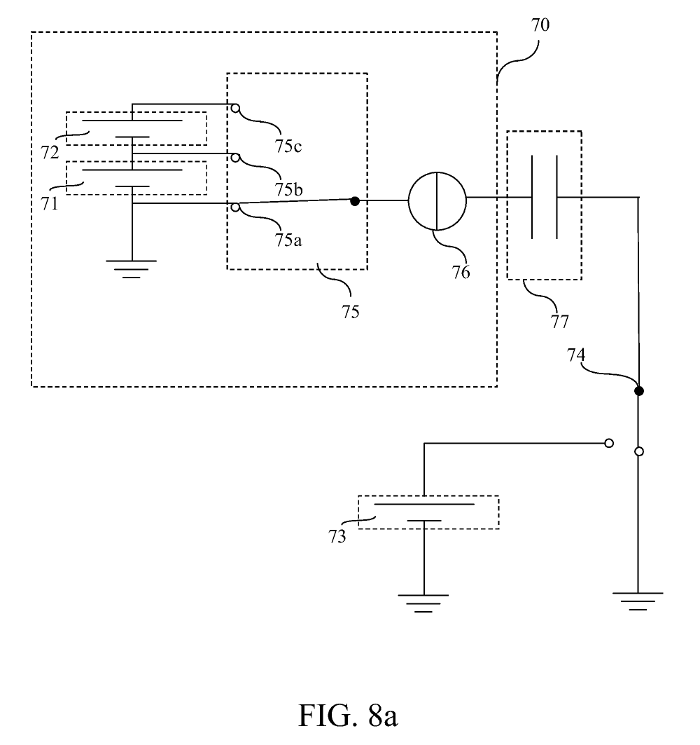

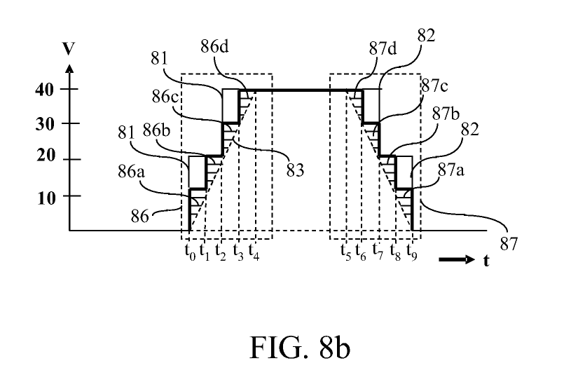

Another embodiment is shown in FIG. 8a. A piezoelectric element 77 is on a first terminal coupled to a switch terminal 74 and on a second terminal to a control circuit 70. The switch terminal 74 is part of a switch which can switch between ground and a first power supply 73. The control circuit 70 comprises a current source 76, a switch 75 and a number of power supplies 71, 72. The switch 76 comprises a number of input terminals 75a, 75b, 75c, which are respectively coupled to ground, a second power supply 71 and a third power supply 72. The supply voltage of the second power supply 71 is 20 V, for example. The supply voltage of the third power supply 72 is 20 V, for example. The supply voltage of the first power supply 73 is 10 V, for example. Essentially, the supply voltage of the first power supply 73 is less, preferably half of the supply voltage of the second power supply 71 and the third power supply 72.

FIG. 8b corresponds to FIG. 8a and shows the voltage over the current source 76 during charging and discharging the piezoelectric element 77. The voltage levels of two voltage ladders 86, 87 are explained here-beneath by means of moments in point of time t₀, t₁, t₂, t₃, t₄, t₅, t₆, t₇, t₈, t₉. A dashed trapezoidal curve 83 shows the voltage differences over the piezoelectric element 77 during an actuation cycle.

Before charging the piezoelectric element 77, the switch position of switch 75 is connected to output terminal 75a, which is connected to ground. The switch terminal 74 is also connected to ground. When the current source 76 is starting to charge the piezoelectric element 77 at a first point of time t₀, the switch position is switched to output terminal 75b and a voltage of 20 V is supplied to the current source 76 and to the second terminal of the piezoelectric element 77. At the same first point of time t₀, the switch terminal 74 is switched to the first power supply 73, which supplies a voltage of 10 V on the first terminal of the piezoelectric element 77. The voltage difference over the current source 76 is therefore less than or equal to 10 V during the time period from point of time t₀ towards point of time t₁.

As soon as the voltage over the piezoelectric element 77 reaches 10 V at point of time t₁, the switch terminal 74 is connected to ground. The voltage over the piezoelectric element 77 increases to 20 V at the point of time t₂. Again the voltage difference over the current source 76 is therefore less than or equal to 10 V during the time period from point of time t₁ towards point of time t₂.

As soon as the voltage over the piezoelectric element 77 reaches 20 V at point of time t₂, the switch terminal 74 is connected to the first power supply 73 supplying a voltage of 10 V. At the same point of time t₂, the switch position of the switch 75 is connected to output terminal 75c and a voltage of 40 V is supplied to the current source 76 and to the second terminal of the piezoelectric element 77. At point of time t₃, the voltage over the piezoelectric element 77 reaches a level of 30 V. Again, the voltage difference over the current source 76 is therefore less than or equal to 10 V during the time period from point of time t₂ towards point of time t₃.

As soon as the voltage over the piezoelectric element 77 reaches 30 V at point of time t₃, the switch terminal 74 is connected to ground. When the voltage over the piezoelectric element 77 reaches a voltage of 40 V at point of time t₄, the piezoelectric element is actuated.

Discharging of the piezoelectric element 77 may be started at point of time t₅ and controlled analogously to controlling the charging of the piezoelectric element 77 by switching at time moments t₆, t₇, t₈, t₉ corresponding to switching to subsequent voltage levels of 30 V, 20 V, 10 V and 0 V, respectively.

It is noted that during the charging of the piezoelectric element 77 the voltage difference over the current source 76 is less than or equal to 10 V. In this manner, a block voltage is supplied to the first terminal of the piezoelectric element 77. The surface of the hatched areas 86a, 86b, 86c, 86d, 87a, 87b, 87c, 87d is a measure of power dissipation of the current source 76. Power dissipation over the current source 76 is approximately halved again with respect to an embodiment in which the first terminal of the piezoelectric element is not connected to a switch terminal, but is directly connected to ground, in which case the voltage would follow a voltage line 81 during charging and a voltage line 82 during discharging.

An embodiment in which the switch terminal 74 and the first power supply 73 are situated between the second power supply 71 and ground and the first terminal of the piezoelectric element 77 is connected directly to ground may reach the same power dissipation reduction. Variations on the number of power supplies connected to either the first terminal or the second terminal of the piezoelectric element 77 may be evident to a skilled person. The first power supply 73 may be a common power supply in the case of a control circuit with a plurality of piezoelectric elements to be controlled.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An inkjet printing apparatus, comprising:
a print head, the print head comprising:
an ink duct;
a piezoelectric element operatively coupled to the ink duct; and
a control device configured to control an ink drop ejection from the ink duct by actuation of the piezoelectric element, the control device comprising:
a current source;
a number of power supplies; and
a switch, connected between the current source and the number of power supplies,
wherein the current source is configured to generate a current for actuating the piezoelectric element by charging and discharging, and the switch is configured to connect the current source and one of said number of power supplies, said one of said number of power supplies being selected such that a lowest voltage difference over the current source exists.

2. The inkjet printing apparatus according to claim 1, wherein the current source is a linear current source.

3. The inkjet printing apparatus according to claim 1, wherein the current source is a voltage controlled current source or a current controlled current source.

4. The inkjet printing apparatus according to claim 1, wherein the current source is a current controlled voltage source.

5. The inkjet printing apparatus according to claim 1, wherein the number of power supplies is connected in series.

6. The inkjet printing apparatus according to claim 2, wherein the number of power supplies is connected in series.

7. The inkjet printing apparatus according to claim 3, wherein the number of power supplies is connected in series.

8. The inkjet printing apparatus according to claim 4, wherein the number of power supplies is connected in series.

9. The inkjet printing apparatus according to claim 1, the inkjet printing apparatus further comprising:
a number of piezoelectric elements; and
a number of current sources,
wherein the number of power supplies and the number of current sources are operatively connected by means of a multiplexer, the multiplexer comprising a number of input terminals and a number of output terminals, wherein each power supply is connected to a respective input terminal and each current source is connected between a respective output terminal and a respective one of the number of piezoelectric elements.

10. The inkjet printing apparatus according to claim 1, the inkjet printing apparatus further comprising a number of piezoelectric elements, wherein each piezoelectric element is connected to a respective current source and each current source is connected to a respective switch.

11. The inkjet printing apparatus according to claim 1, the inkjet printing apparatus further comprising a number of piezoelectric elements, wherein each piezoelectric element is connected to a respective current source and each current source is connected to the same switch.
